(19) United States
(12) Patent Application Publication
(10) Pub. No.: US 2016/0092981 A1
(43) Pub. Date: Mar. 31, 2016

(54) APPARATUS, METHOD, AND COMPUTER PROGRAM PRODUCT FOR EXTRACTING INSIGHTS FROM BILL PRESENTMENT DATA

(71) Applicant: MasterCard International Incorporated, Purchase, NY (US)

(72) Inventor: Debashis Ghosh, Charlotte, NC (US)

(21) Appl. No.: 14/496,572

(22) Filed: Sep. 25, 2014

(51) Int. Cl. G06Q 40/02; G06Q 40/00

(52) U.S. Cl. CPC G06Q 40/025; G06Q 40/12

(57) ABSTRACT

Access is obtained to a database of bill presentment data in an electronic bill presentment system connecting a plurality of customers with a plurality of billers. At least some of the billers are payment card issuers. At least one presentment record for at least one of the customers is extracted from the database of bill presentment data. Based on the at least one presentment record for the at least one of the customers, at least one of credit worthiness of the at least one of the customers and payment history of the at least one of the customers is determined.

### FIELD OF THE INVENTION

The present invention relates generally to the electronic and computer arts, and, more particularly, to analysis of electronic bill presentment techniques.

### BACKGROUND OF THE INVENTION

The use of payment cards, such as credit cards, debit cards, and pre-paid cards, has become ubiquitous. Most payment card accounts have one or more associated physical cards; however, the use of non-traditional payment devices, such as appropriately configured “smart” cellular telephones, is increasing. A wealth of transaction data is available, based on the use of payment card accounts.

The process of electronic bill presentment and payment has also been popular for quite some time. For example, U.S. Pat. No. 5,699,528 to Hogan (expressly incorporated herein by reference in its entirety for all purposes) discloses a system and method for bill delivery and payment over a communications network. In the bill delivery and payment system, users are able to access a server computer on a communications network to obtain bill information and pay bills.

Credit card issuers seek to ensure that credit cards, with their associated lines of credit, are only issued to suitably credit-worthy individuals, and/or that lines of credit are adjusted to reflect cardholders' current levels of creditworthiness.

### SUMMARY OF THE INVENTION

Principles of the present invention provide techniques for extracting insights from bill presentment data. In some instances, at least some aspects of the techniques may be facilitated by the operator of an electronic bill presentment system, optionally with payment functionality (electronic BPPS) and/or payment card network, or other service provider.

In one aspect, an exemplary method includes the step of obtaining access to a database of bill presentment data in an electronic bill presentment system connecting a plurality of customers with a plurality of billers. At least some of the billers are payment card issuers. A further step includes extracting from the database of bill presentment data at least one presentment record for at least one of the customers. A still further step includes determining, based on the at least one presentment record for the at least one of the customers, at least one of credit worthiness of the at least one of the customers and payment history of the at least one of the customers.

Aspects of the invention contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the invention can provide substantial beneficial technical effects.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the invention;

FIG. 3 shows exemplary operation of a bill presentment and payment system (BPPS), in accordance with an aspect of the invention;

FIG. 4 shows exemplary operation of current automated clearinghouse payments;

FIG. 5 is a block diagram of an exemplary computer system useful in one or more embodiments of the invention; and

FIG. 6 shows exemplary system output in the form of a plurality of bar graphs, in accordance with an aspect of the invention.

### DETAILED DESCRIPTION OF PREFERRED EMBODIMENTS

One or more embodiments employ bill presentment data from electronic bill presentment systems or the like (such systems may also have payment capability—such as in bill presentment and payment systems) to obtain insights useful in connection with risk mitigation of credit portfolios (by way of a non-limiting example, unsecured lines of credit, such as for credit card accounts). Some embodiments could optionally also use transaction data from payment card networks. Some embodiments also can also be used in connection with secured lines of credit such as home equity lines of credit. Regardless of whether transaction data from payment card networks is employed, one or more embodiments can be used to mitigate risk in connection with credit card accounts. It is worth noting that bill presentment data typically will include a due date, a minimum payment due, and a total balance. The credit limit is typically not explicitly available. In some embodiments, it can be inferred that the credit limit is at least as much as the largest historical balance (i.e., largest outstanding balance in a time series that covers some period of interest).

### Payment Devices and Associated Payment Processing Networks

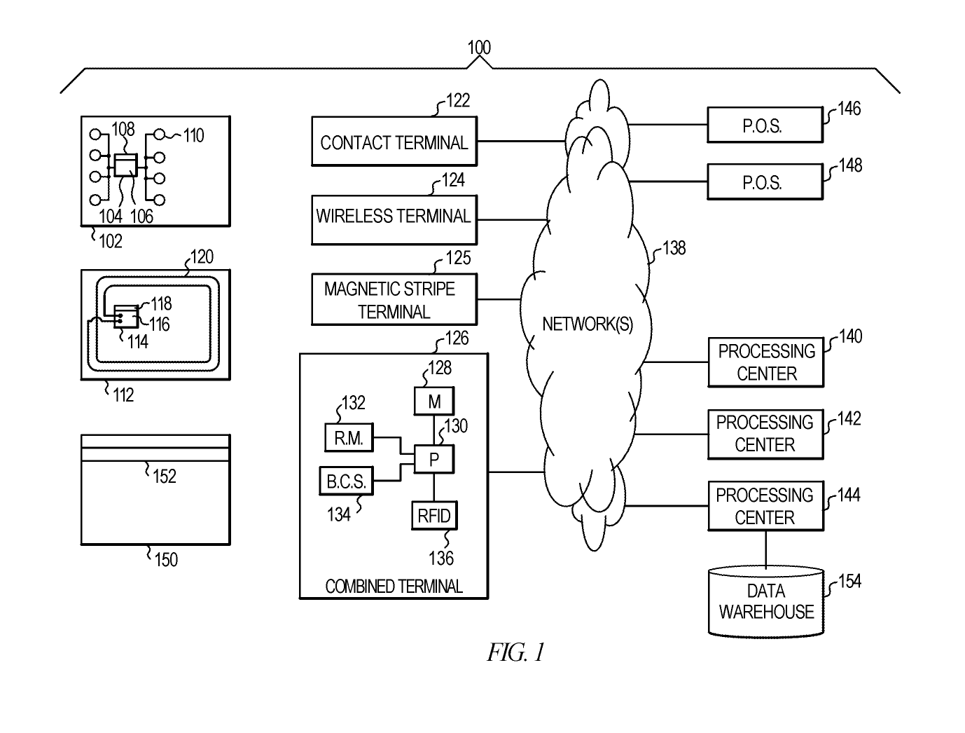

With regard to payment card and similar payments, attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present invention is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

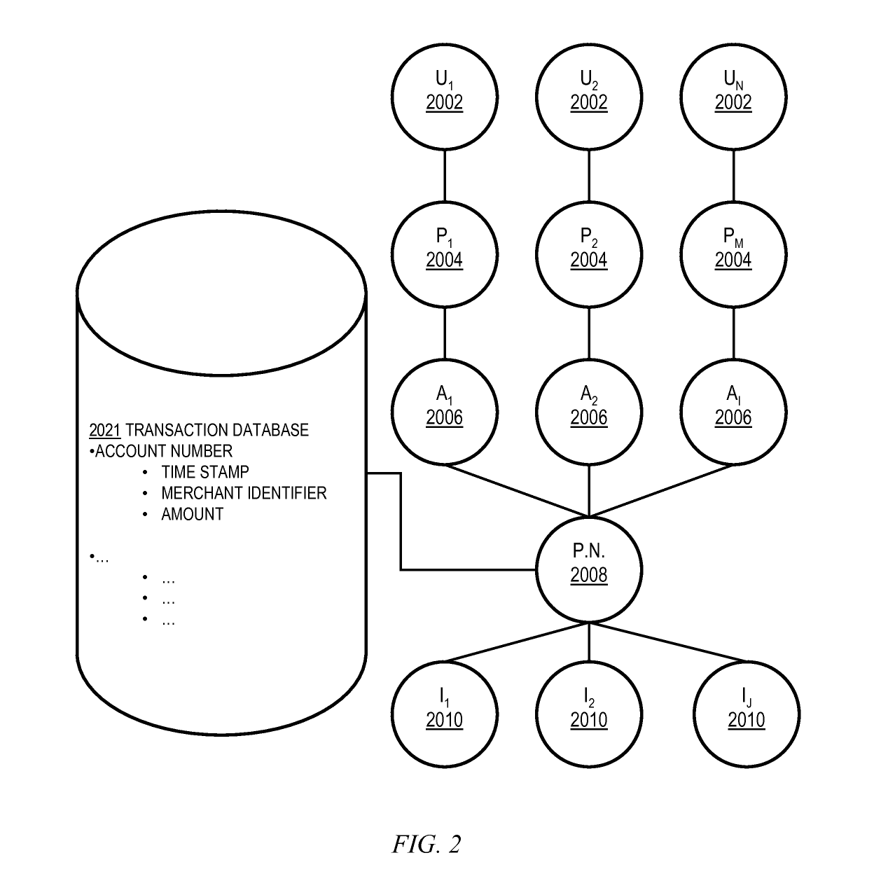

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

Transaction database 2021 may include, for example, a plurality of records for a plurality of different transactions with a plurality of different account numbers (PANs) for a single brand of payment card products, MASTERCARD cards being a non-limiting example. The record for each transaction may include, for example, the PAN or other account number, a time stamp, a merchant identifier, and the amount. The ellipses indicate that each PAN has many transactions, and that there are many PANs. Transactions can be, for example, in-person transactions at brick and mortar locations, or on-line (Internet) transactions.

It will be appreciated that the network 2008 shown in FIG. 2 is an example of a payment network configured to facilitate transactions between multiple issuers and multiple acquirers, which may be thought of as an “open” system. Some embodiments of the invention may be employed to carry out tender type scaling in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN)(which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

Electronic Bill Presentment and/or Payment Systems

As noted, one or more embodiments employ data from electronic bill presentment systems (optionally with payment functionality) (BPPS) to obtain insight useful in connection with risk mitigation of credit portfolios. Electronic bill presentment and payment systems are conceptually different than payment card networks, and will often use electronic funds transfer from a demand deposit account. In some instances, a single entity, such as MasterCard International Incorporated (a non-limiting example) will operate both a payment card network and an electronic bill presentment and payment system.

With regard to electronic bill presentment and payment systems, inventive techniques can be employed in a number of different environments. In one or more embodiments, inventive techniques can be employed in connection with the MASTERCARD RPPS® electronic payment system of MasterCard International Incorporated of Purchase, N.Y., USA. This example is non-limiting; for example, other types of electronic bill presentment and/or payment systems could be employed in other instances. Non-limiting examples are is described in:
US Patent Publication 2011-0251952 A1 of Mary L. Kelly et al.
US Patent Publication 2012-0197788 A1 of Hemal Sanghvi et al.
US Patent Publication 2013-0290177 A1 of Amy Christine Milam and Stephen Joseph Klaus.
US Patent Publication 2013-0311362 A1 of Amy C. Milam et al.

The above-listed Kelly et al., Sanghvi et al., Milam/Klaus, and Milam et al. publications are hereby expressly incorporated by reference herein in their entireties for all purposes.

For the avoidance of doubt, references to MasterCard, unless expressly stated to be limited to MasterCard, are intended to be exemplary of an operator of an electronic BPPS and/or an operator of a payment card network, as will be appreciated from the context, whether or not qualified by words such as “or other operator.”

Furthermore, another non-limiting example of an electronic BPPS with which one or more embodiments of the invention can be employed is the CHECKFREE® platform available from Fiserv, Inc. of Brookfield, Wis., USA.

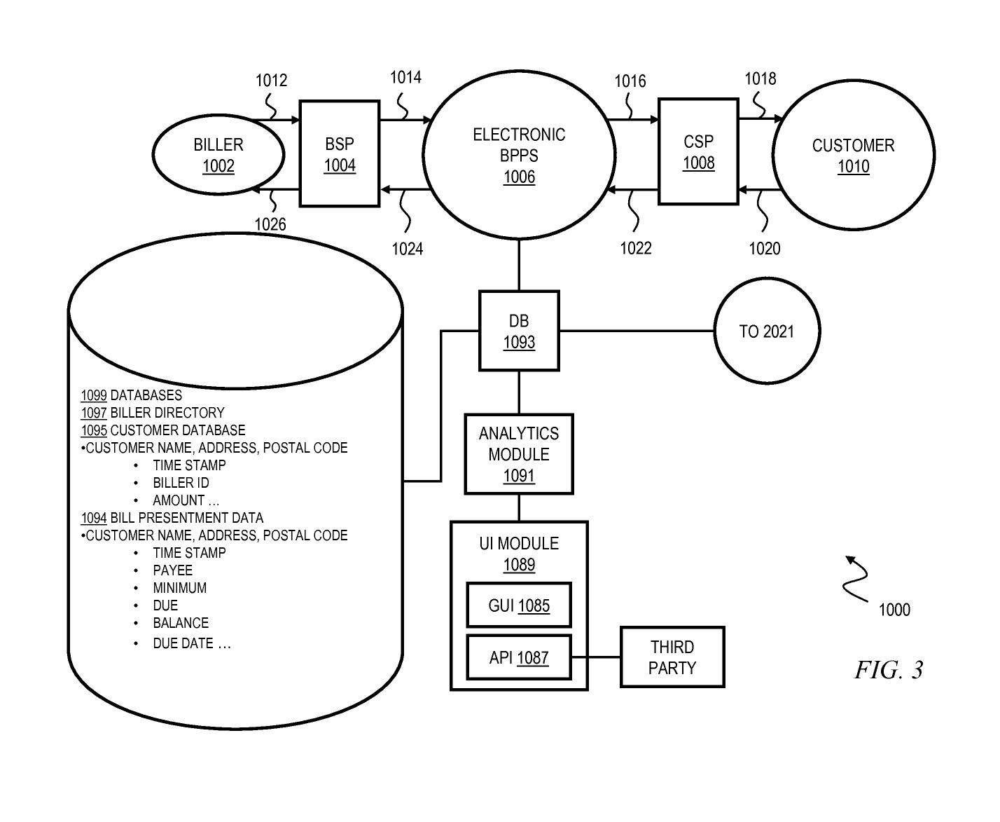

FIG. 3 shows operation of an electronic BPPS, such as the MASTERCARD RPPS® electronic bill presentment and payment system, which is but one non-limiting example of such a system, modified in accordance with aspects of the invention. Given the teachings herein, the skilled artisan will be able to implement one or more embodiments of the invention using a variety of techniques; by way of example and not limitation, the modification or supplementing of an existing MASTERCARD RPPS® system or other electronic BPPS as shown in FIG. 3. As shown in FIG. 3, in an approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic BPPS 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

Note that in some instances, billers 1002 can connect directly to BPPS 1006 without the use of BSP 1004. In such cases, billers 1002 exchange presentment and payment data directly with BPPS 1006.

Database(s) 1099 including biller directory 1097, customer database 1095, and bill presentment database 1094 are described further below.

Again, note that “BPPS” is used herein as shorthand for an electronic “bill presentment and payment system”; the RPPS system is a non-limiting example of such a system. Furthermore, some embodiments utilize only bill presentment functionality and do not require bill payment functionality.

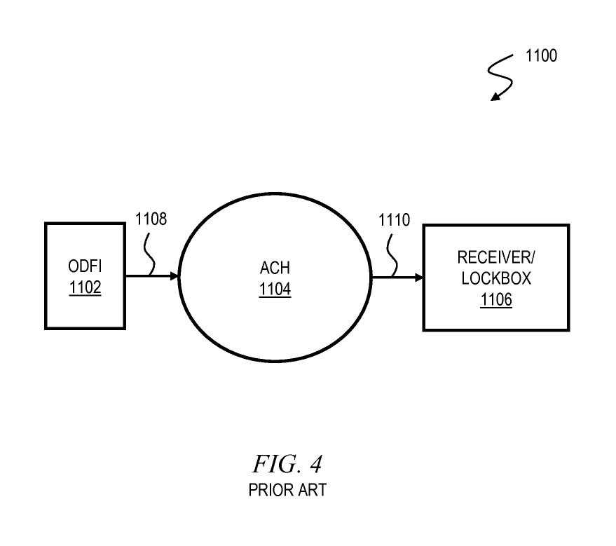

FIG. 4 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; non-limiting examples of ACH file formats include the NACHA ACH CIE, NACHA ACH PPD, or NACHA ACH CCD (e.g. for corporate-to-corporate cases) file formats. Other formats can also be used; for example, extensible markup language (XML). It should be noted that a variety of networks can be used, both public (for example, ACH) and proprietary (for example, the aforementioned MASTERCARD RPPS system).

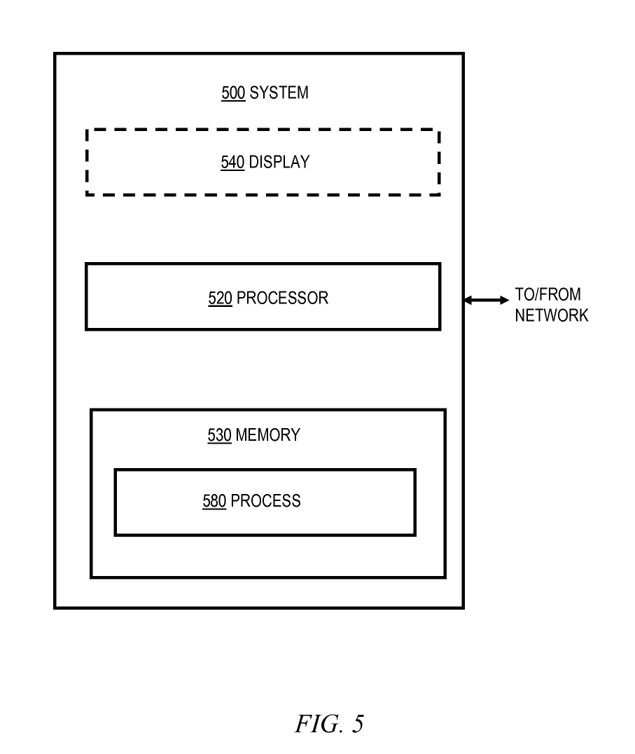

As used herein, an “electronic bill presentment system using customer service providers” refers to a system wherein electronic bills are distributed from billers, through an aggregator switch, out to financial institutions or other customer service providers such that those financial institutions or other customer service providers can display the electronic bills, through the financial institutions' or other customer service providers' own on-line banking interface, to bill-paying customers of the financial institutions or other customer service providers. FIG. 5 of the above-referenced US Patent Publication 2011-0251952 A1 of Mary L. Kelly et al. shows an exemplary block diagram of an electronic bill presentment system, including a bill payment platform and a bill presentment platform; the bill payment platform may utilize techniques disclosed in the above-referenced US Patent Publication 2012-0197788 A1 of Hemal Sanghvi et al.

Some electronic bill payment systems use the NACHA ACH Standard Entry Class (SEC) formats, such as CIE (Customer Initiated Entries), CTX (Corporate trade exchange); CCD (Cash Concentration or Disbursement); or PPD (Prearranged payment and deposits). Some electronic bill payment systems use a modified form of the NACHA CIE (MOD-CIE) wherein a payment system operator requires specific values for certain fields. Some electronic bill payment systems (e.g., MASTERCARD RPPS) provide translation capability and can receive input in many different formats, translate it for internal use, and translate it again for output in many different formats, which may be the same as or different from the input formats. Some electronic bill payment systems provide customer service providers with the capability to specify when the electronic bill payment system will look to them for payment instructions. Some electronic bill payment systems provide biller service providers with the capability to specify when the electronic bill payment system will initiate payments. FIG. 5 of the above-referenced US Patent Publication 2012-0197788 A1 of Hemal Sanghvi et al. shows an exemplary system interfaces of an electronic bill payment system.

As noted above, electronic bill presentment and payment systems are conceptually different than payment card networks, and will often use electronic funds transfer from a demand deposit account. Nevertheless, some electronic bill presentment and/or payment systems receive and send data over a network such as is shown in FIG. 2, using capability such as MasterCard Global File Transfer (GFT). Furthermore, US Patent Publication 2010-0100480 of Theresa Altman et al., hereby expressly incorporated by reference herein in its entirety for all purposes, describes a system wherein payment of a bill using a payment card account is facilitated by formatting and dispatching a message from a bill payment provider to an electronic bill payment system. The message is flagged with a flag indicating that the message comprises a non-financial, card payment, message. The message includes an identification of the biller, a card number of the payment card account, and an expiration date of the payment card account. The message is an electronic funds transfer message augmented with the flag, the card number, and the expiration date.

Some electronic bill payment systems use technology such as described in the above-referenced US Patent Publication 2013-0290177 A1 of Milam and Klaus to reduce the number of non-electronic payments. Some electronic bill payment systems use technology such as described in the above-referenced US Patent Publication 2013-0311362 A1 of Amy C. Milam et al. to facilitate approximately matching entered payee information to stored biller information.

Extracting Insights from Bill Presentment Data

Again, as noted above, one or more embodiments employ data from electronic bill presentment systems (optionally with payment functionality) (BPPS) to obtain insights useful in connection with risk mitigation of credit portfolios. A BPPS can be used for many different kinds of payments; for example, payments to a utility company, a cable television provider, and so on. Many people use a system such as system 1000 to pay credit card issuers. For example, a consumer pays the issuer of his or her MasterCard® card or VISA® card using an online bill payment with a transfer from a demand deposit account (MasterCard® and VISA® are registered marks of, respectively, MasterCard International Incorporated, Purchase, N.Y., USA, and Visa International Service Association, Foster City, Calif., USA).

Data in payment card transaction database 2021, by itself, typically will not permit determination of whether a cardholder is a revolver (i.e., carries a balance) or pays off his or her balances on time. The use of presentment data, such as from BPPS data 1099, offers an enriched view of the customer beyond what can be obtained from looking only at the payment card transaction data.

As noted, in one or more embodiments, database(s) 1099 include biller directory 1097, customer database 1095, and bill presentment database 1094 (e.g., with raw presentment data). Consider that, in a non-limiting example, bill presentment can be carried out via a web site operated by an underlying bank. The bank will typically have a Party ID and Party Collection ID. The Party ID will identify unique individuals. The Party Collection ID will be for a household including one or more individuals. Thus, customer database 1095 can include household IDs with associated data and individual IDs with associated data.

The following is a non-limiting example of bill presentment data such as would typically be available in database 1094, representing bill presentment as described with regard to 1012, 1014, 1016, 1018. Of course, there would be many users of the electronic BPPS, and there would typically be many bill presentment records for each user.

### Payee: Citi MasterCard

### Minimum: $887

### Balance: $36,000

### Due Date: Apr. 15, 2015

Here, the person is carrying a balance of $36,000; his or her minimum payment due is $887, and the payment is due by Apr. 15, 2015. As noted above, bill presentment data typically will include a due date, a minimum payment due, and a total balance. The credit limit or remaining amount open to spend are typically not explicitly available. In some embodiments, it can be inferred that the credit limit is at least as much as the largest historical balance (i.e., largest outstanding balance in a time series that covers some period of interest, say 18-36 months (a non-limiting example)). Thus, one or more embodiments look for the highest balance in the presentment data during a predetermined period of time, and using same to infer the available credit limit.

One or more embodiments carry out data mining on one or more of the databases 1099.

Consider that the exemplary presentment data shown above for “Citi MasterCard” is representative of bill presentment data that will be in database 1094 for many different bills; e.g., Citi MasterCard, Bank of America MasterCard, Chase VISA, electric company, telephone company, etc. Such data can be mined and analyzed in a number of different ways to obtain useful information.

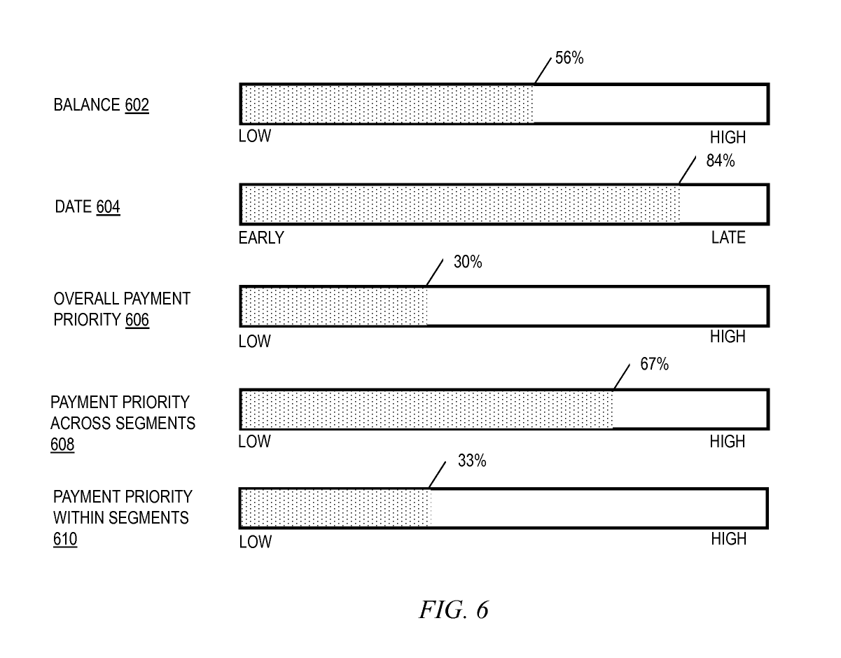

Refer now to FIG. 6. Bar graph 602 shows the balance as a percentage of the available credit line. Here, the subject has a balance equal to 56% of the available line of credit. This could be shown (as in the example) for a single credit card account, for multiple accounts, or even for all available credit card accounts.

As noted elsewhere, the available credit line is typically not known from presentment data per se, but can be approximated as the largest outstanding balance over some predetermined time period. It can be inferred that the available credit line is at least that large. In this aspect, run a query on bill presentment data 1094 for records for the customer of interest (based on his or her name, unique alpha-numeric identifier, or the like). Within those records, find all the presentment records for the payment card(s) of interest for the predetermined time of interest. For each given card, find the maximum outstanding balance over the predetermined time period, and take that as the available credit line.

Now, with the inferred available credit line for one or more card accounts, in some embodiments, extract from the presentment records the current balance and divide by the inferred available credit line, optionally multiplying by 100 to obtain a percentage. In some embodiments, this is done only for the current balance. In other embodiments, examine historical presentment data over some period of time to obtain previous values of the outstanding balance and extract averages, examine trends, or the like. For the avoidance of doubt, where the available credit line is approximated as the largest outstanding balance over some predetermined time period, the historical balances will be reviewed for purposes of approximating the available credit line, even if the calculation of balance as a fraction or percentage of the available credit line is only being done for the current balance.

In one or more embodiments, query first on the customer ID to locate records for a customer of interest. Then, conduct one or more suitable queries for the card account(s) of interest. For example, query on a nickname (e.g., “Chase Visa 0389” where 0389 are the last four digits of the account number) for the card account of interest, or even on the PAN number for the card account of interest, where appropriate. Of course, all applicable laws, rules, regulations, and standards relating to privacy protection should always be followed, and PAN numbers should only be stored in a PCI-compliant manner. In one embodiment, opt-in is obtained before utilizing the PAN number. The aforementioned queries can be carried out using SQL statements, for example. In an alternative approach, query on payee name for names of payees that are known to be credit card issuers, or query on Biller ID for payees that are known to be credit card issuers.

Where a single account is being analyzed, divide the current balance for the account (say, $2800) by the estimated credit line (say, $5000), and optionally multiply by one hundred to obtain the percentage; here, 56%. Where multiple accounts are being analyzed, sum up the current balance for all the accounts, divide by the sum of all the estimated credit lines for all the accounts, and multiply by one hundred to obtain the percentage.

Some embodiments also show what percentage of the total amount due the person typically pays each month. In these cases, use is made of payment as well as presentment data. For example, query presentment data 1094 to obtain the total amount due for each of one or more time periods and/or one or more accounts. Then, query payment data (e.g., in database 1095) to find the corresponding payments. For example, query for payments made within one month of presentment to a payee or Biller ID corresponding to the bill presenter. If looking at a single account, for each month, divide the amount paid by the total amount due to obtain a fraction, and optionally multiply by one hundred to obtain a percent. Then, present the results for one or more months. If looking at multiple accounts, for each time period (e.g., month), add up the total amount paid on all accounts; add up the total amount due on all accounts, and divide the former by the latter. Then, present the results for one or more months.

Bar graph 604 shows that the subject may be somewhat financially “stretched” because he or she tends to make payments close to the due date. Suppose the subject has a bill presentment on July 1, and it is due in one month, on August 1. Suppose the subject pays on July 27, close to the due date. Financially healthy people may pay sooner rather than later. People with liquidity problems may pay later rather than sooner. Graph 604 shows the percentage of the one month used up before payment. For example, it is 31 days from Jul. 1, 2015 to Aug. 1, 2015. It is 26 days from Jul. 1, 2015 to Jul. 27, 2015. Twenty six divided by thirty one is 0.8387, or 83.87%, about 84% as seen at 604. This could be done for multiple cards and/or for multiple time periods. Average the percentages for each of the card(s) for the time period(s) of interest. A bar graph showing the average across cards can be displayed for each time period, a time series plot can be shown, and so on.

Bar graph 606 shows whether the subject tends to first pay bills for credit card balances or for other items (e.g., rent; mortgage; consumer items such as Netflix movie service, car payment, etc.). In this aspect, run a query on bill presentment data 1094 for records for the customer of interest (based on his or her name, unique alpha-numeric identifier, or the like). Within those records, for some predetermined amount of presentment data (e.g., one month, 6 months, one year, two years) for billers who represent credit card issuers, extract from the presentment records the payment due date. In this latter aspect, for example, as discussed above, query on a nickname (e.g., “Chase Visa 0389” where 0389 are the last four digits of the account number) for the card account of interest; on the PAN number for the card account of interest where appropriate; on payee name for names of payees that are known to be credit card issuers, or on Biller ID for payees that are known to be credit card issuers.

Suppose, for example, the month of June is of interest. Suppose further that there are eleven bills for the month of June. Assign an integer to each payment of interest, whether for a card or for another bill; e.g., Low=1, High=11. Suppose the card of interest is paid 8^{th} out of 11 total payments. Make a ranked list based on the order of payment. The card paid 11^{th} of the 11 payments is assigned a value of zero; the card paid first of the 1 payments is assigned a value of 1 (fractional) or 100 (percentage); the payments paid in between these two extremes are assigned the corresponding fraction. The following formulas can be used:

Fractional Rank=(total number−order in which paid)/(total number−1)

Percentage Rank=Fractional Rank*100

In the example of interest, Fractional Rank=(11−8)/(11−1)=0.30 and Percentage Rank=30%.

Optionally, payment data over time could be analyzed. For example, determine an average (straight or weighted) of the rank for payment of the bill of interest. A weighted average could give greater weight to more recent payments, for example.

As noted, the ranking will include payments to payment card issuers and other kinds of payments; e.g., mortgage, rent, auto loan, utilities, etc. Given the teachings herein, the skilled artisan will be able to design appropriate queries to obtain the information of interest. For example, within the records for the customer of interest, for some predetermined amount of presentment data (e.g., 6 months, one year, two years) for billers who represent landlord(s), mortgage holders, auto finance companies, or utilities, as the case may be, extract from the presentment records the payment due date. In this latter aspect, query, for example, on payee name for names of payees that are known to be landlord(s), mortgage holders, auto finance companies, or utilities, as the case may be (e.g., “ACME Bank Residential Mortgages,” “Avalon Homes,” “GMAC,” “Con Edison”), or look for a nickname or memo such as “rent,” “mortgage,” “car,” “electric” or an identical amount every month for a predetermined amount of time (e.g., 15-16 months) and optionally for an amount in a predetermined range corresponding to typical rent, car loans, or mortgage payments in the subject's neighborhood (electric bills might vary in a predictable way seasonally and this type of pattern could be examined for). Many people who pay rent will not also pay a mortgage; however, someone might have a mortgage on a primary residence and rent a vacation residence, or vice-versa. Thus, in addition to, or instead of, examining rent payments to landlords, within the records for the customer of interest, for some predetermined amount of presentment data (e.g., 6 months, one year, two years) for billers who represent mortgage holder(s), extract from the presentment records the payment due date.

Bar graph 608 shows, within payment cards, whether the subject tends to pay bank cards or store cards first (i.e., across segments). In this aspect, run a query on bill presentment data 1094 for records for the customer of interest (based on his or her name, unique alpha-numeric identifier, or the like). Within those records, for some predetermined amount of presentment data (e.g., one month, 6 months, one year, two years) for billers who represent payment card issuers, extract from the presentment records the payment due date. In this latter aspect, for example, as discussed above, query on a nickname (e.g., “Chase Visa 0389” where 0389 are the last four digits of the account number) for the card account of interest; on the PAN number for the card account of interest where appropriate; on payee name for names of payees that are known to be credit card issuers, or on Biller ID for payees that are known to be credit card issuers. Similarly, within the records for the customer of interest, for some predetermined amount of presentment data (e.g., one month, 6 months, one year, two years) for billers who represent store cards, extract from the presentment records the payment due date. In this latter aspect, query, for example, on a nickname (e.g., “Macy's” or Macy's 0123″ where 0123 are the last four digits of the store card account number) for the card account of interest; on the card number for the card account of interest where appropriate; on payee name for names of payees that are known to be store card issuers, or on Biller ID for payees that are known to be store card issuers. In a non-limiting example, the Fractional Rank and Percentage Rank formulas above can be used. For example, suppose the subject has Store Card A, Store Card B, Bank Card C, and Bank Card D. In a given month, suppose Bank Card C is paid second out of the four cards. For Bank Card C for that month, Fractional Rank=(4−2)/(4−1)=0.6667, and Percentage Rank=66.67% or about 67%, as seen in FIG. 6 at 608.

Optionally, payment data over time could be analyzed. For example, determine an average (straight or weighted) of the rank for payment of the card of interest. A weighted average could give greater weight to more recent payments, for example.

Bar graph 610 shows, within a given segment (e.g., bank-issued credit cards), which card the subject tends to pay first. In this aspect, run a query on bill presentment data 1094 for records for the customer of interest (based on his or her name, unique alpha-numeric identifier, or the like). Within those records, for some predetermined amount of presentment data (e.g., 6 months, one year, two years) for billers who represent bank credit card issuers, extract from the presentment records the payment due date. In this latter aspect, for example, as discussed above, query on a nickname (e.g., “Chase Visa 0389” where 0389 are the last four digits of the account number) for the card account of interest; on the PAN number for the card account of interest where appropriate; on payee name for names of payees that are known to be credit card issuers, or on Biller ID for payees that are known to be credit card issuers. In a non-limiting example, the Fractional Rank and Percentage Rank formulas above can be used. For example, suppose the subject has Bank Card A, Bank Card B, Bank Card C, and Bank Card D. In a given month, suppose Bank Card A is paid third out of the four cards. For Bank Card A for that month, Fractional Rank=(4−3)/(4−1)=0.3333, and Percentage Rank=33.33% or about 33%, as seen in FIG. 6 at 610.

Optionally, payment data over time could be analyzed. For example, determine an average (straight or weighted) of the rank for payment of the card of interest. A weighted average could give greater weight to more recent payments, for example.

Thus, in one or more embodiments, bill presentment data is employed. Bills may be presented to a subject by having him or her log into a web site or receive an e-mail, for example. The subject thus becomes aware of bills that must be paid. The subject may choose to pay online with an electronic BPPS (e.g., from a demand deposit account (DDA) via wire transfer or automated clearinghouse (ACH)). The bills that are presented can be for many different things; for example, electric utility, gas utility, Chase VISA bank credit card, Bank of America MasterCard bank credit card, etc. In one or more embodiments the bill presentment data is transmitted to the subject over an electronic BPPS, as seen in FIG. 3. The subject then issues appropriate payment instructions. Analyzing the bill presentment and/or payment data available to the operator of the electronic BPPS allows for gaining insight into the subject's credit worthiness and payment history.

As explained with respect to bar graph 602, it is possible to determine the kind of average balance the person carries. If close to the limit, it may suggest that the person is not a good credit risk. Conversely, if the person is paying a large amount or even the total due every month, this suggests that the person is not carrying a large balance and may be a good credit risk.

As explained with respect to bar graph 604, if a person typically pays near or even past the due date, it may suggest that the person is not a good credit risk. Conversely, if the person typically pays well before the due date, this suggests that the person may be a good credit risk.

In one or more embodiments, data obtained allows an extender of credit to intelligently manage a credit portfolio. If a subject seems problematic, the subject's credit line may be reduced. Such active management reduces the chance of a balance being charged off (charge off is when the account is written off as a bad debt).

In some embodiments, an entity that operates an electronic BPPS could make this type of information available as a service to payment card issuers. In such a case, for example, the entity could simply provide the data and allow the issuer to make actual determinations as to the significance of the data and whether the subject's credit line should be changed. As noted above, of course, all applicable laws, rules, regulations, and standards relating to privacy protection should always be followed. In this regard, it should be noted that one or more embodiments use the data for purposes of risk mitigation of credit portfolios and not for marketing purposes. In one embodiment, opt-in is obtained.

It will be appreciated that one or more embodiments include a particular machine such as shown in FIG. 3. A database system 1093 accesses databases 1099 (including, e.g., biller directory 1097, customer database 1095, and bill presentment database 1094), and optionally database 2021. Database system 1093 may be, for example, a graph database such as Neo4j, an open-source graph database, implemented in Java, available from Neo Technology Inc., San Mateo, Calif., USA. In an alternative approach, database system 1093 could be a relational database management system (RDBMS). Compared with relational databases, however, graph databases may be more suitable in one or more embodiments since they can more efficiently find, for example, all persons in a bill presentment database 1094 or other one of the databases 1099, and/or in payment card transaction database 2021, who hold cards issued by a certain bank and or have engaged in transactions with a certain store.

Databases 1099 can include bill presentment database 1094; Customer database 1095 with the customer's name, address, and postal code, and for each payment, time stamp for the payment, Biller ID, and amount; and a Biller Directory 1097. One or more embodiments make particular use of bill presentment database 1094. MasterCard's RPPS Biller Directory is a non-limiting example of biller directory 1097. Each biller in the biller directory is identified by a unique Biller ID. Records in the biller directory 1097 will also typically include the name and address information for the biller corresponding to the Biller ID, as well as the biller's demand deposit account to which payments should be routed. Of courses, other embodiments could use a different database configuration than that shown and described herein.

Thus, for a customer “JOHN SMITH” there may be, say fifty bill presentments, such as for the electric utility, gas utility, refuse hauler, five different credit card statements, and the like all categorized under the same customer number (e.g., unique alphanumeric designator of the particular customer). Such data may typically be available for millions of customers. Data for each biller may include, for example, the company's address, e-mail, customer service number, and the like. Thus, using a customer database 1095, presentment database 1094, and biller database 1097 in a BPPS, query one or more of the databases with database system 1093 and determine what billers have been billing JOHN SMITH, in what order JOHN SMITH pays the billers, and/or other useful information as described herein. For presentments related to credit card bills, determine whether there is a minimum payment and a total balance in the presentment data, for example.

It should be noted that in some cases, some data referred to as residing in customer database 1095 (e.g., customer's home address) may be maintained by customer service provider(s) 1008 rather than electronic BPPS 1006; database 1095 may thus, in some cases, be implemented as a composite of several databases maintained by customer service provider(s) 1008 and electronic BPPS 1006.

Furthermore with regard to system 1000, an order 1020, 1022 to pay will typically include an identification of the biller 1002 and the amount. Data in biller directory 1097 is useful, for example, where payments are made to an entity such as “Card Member Services”; the Biller Directory can be consulted to determine who the corresponding payee is (name of issuer and optionally corresponding brand of payment card products; in at least some instances, the corresponding brand of payment card products is instead determined by checking the leading digit(s) of the card account number (e.g., PAN or bank card number) in a manner that is, in and of itself, known to the skilled artisan). In still another alternative, the name of the issuer and/or the corresponding brand of payment card products can be determined from the memo field(s) of the on-line payment(s). In yet a further alternative, the name of the issuer and/or the corresponding brand of payment card products can be determined directly from the payee information.

Again, each customer 1010 may have records in customer database 1095. These records may show the customer's name, address, and ZIP or other postal code. Many transactions, including, for each transaction, a time stamp, biller ID, and amount, will be associated with each customer. The ellipses indicate that each customer has many transactions, and that there are many customers.

In some embodiments, instead of first determining which payments are to specific issuers, and then averaging the timing of all the payments to issuers of a particular brand, filter on payment card account number or the like to directly determine that a payment is for a specific brand of payment card and issuer.

Some embodiments allow for filtering payments based on source and destination.

Some embodiments further determine whether a payment is payment in full, or just the minimum payment, or some intermediate amount, using bill payment data in addition to the bill presentment data.

One practical application of one or more embodiments is for a payee, responsive to noting that they are not paid in a prioritized manner, offering the payor an incentive to pay them earlier. For example, the payee sees that they are paid late in graph 604 or that their priority is low in any of 606, 608, or 610. They then offer the payor an incentive to prioritize payments to them.

Another practical application of one or more embodiments is cash flow management based on credit scoring. For example, a biller (e.g. a utility provider, landlord, or credit card issuer) may set a time period of from about one week to about one month during which a bill (e.g., electric bill, rent, or credit card bill) can be paid without being considered late. Propensity to pay early or to pay late can be determined using techniques set forth herein. The entity can use that propensity data to project its own cash flows and determine if it will likely need to access a line of credit to cover its own costs (e.g., payroll, mortgage payments on rental property) due to a significant number of individuals paying towards the end of the aforementioned time period, or even beyond that time period. The entity can also use the propensity data (subject, of course, to all applicable laws, rules, and regulations such as those governing utility providers and landlords) to determine whether to extend further credit in the future or to renew a lease, e.g. The propensity data can be used to supplement FICO or other credit scores or the like.

Given the discussion thus far, it will be appreciated that, in general terms, an exemplary method, according to an aspect of invention, includes the step of obtaining access to a database 1094 of bill presentment data in an electronic bill presentment system (e.g., BPPS 1006) connecting a plurality of customers 1010 with a plurality of billers 1002. At least some of the billers are payment card issuers (e.g., 2010). This step can be carried out, for example, using database system 1093. A further step includes extracting, from the database of bill presentment data 1094, at least one presentment record for at least one of the customers 1010. This step can be carried out, for example, using database system 1093, by running one or more suitable queries. Exemplary queries are discussed elsewhere herein; in some cases, querying can be via Party ID and/or Party Collection ID as discussed above.

A still further step includes determining, based on the at least one presentment record for the at least one of the customers, at least one of credit worthiness of the at least one of the customers and payment history of the at least one of the customers. This step can be carried out, for example, with analytics module 1091. In some instances, this step can be carried out by an entity that operates BPPS 1006 and/or network 2008; for example, MasterCard International Incorporated of Purchase, N.Y., USA. In some cases, this step involves developing data that may be presented in graphical form, such as seen in FIG. 6. In some instances, the entity that carries out this step makes the results available to another entity such as an issuing bank (e.g., 2010), which in turn decides what action, if any, should be taken based on the results.

In some instances, the obtaining, extracting, and determining steps are all carried out by the operator of the electronic bill presentment system (which could be an electronic bill presentment and payment system).

As noted, in some cases, an additional step includes making credit worthiness and/or payment history of the at least one of the customers available to at least one of the payment card issuers. This step could be carried out, for example, with user interface module 1089 which can include an application program interface (API) 1087 to the issuers and/or a GUI 1085.

In some embodiments, the credit worthiness and/or payment history of the at least one of the customers includes at least an indication that the at least one of the customers is not prioritizing payments to at least one of the billers. In such instances, a further step includes the at least one of the billers offering the at least one of the customers an incentive for early payment. Optionally, the entity that carries out the determining step uses UI module 1089 to advise the at least one of the billers that their payments are not being prioritized. The method can include this advising step and/or the step of the at least one of the billers offering the at least one of the customers the incentive.

Referring to bar graph 602, in some instances, the at least one presentment record for the at least one of the customers includes a presentment record for a bill of a credit card. The credit card was issued to the at least one of the customers by one of the payment card issuers. The extracting includes obtaining, from the presentment record for the bill of the credit card, the current balance (e.g., with database system 1093); and dividing the current balance by the total credit line to obtain the fraction of the total credit line used up (e.g., with analytics module 1091). Optionally, multiply by 100 with analytics module 1091 to obtain a percentage. The fraction (or percentage) is indicative of the credit worthiness of the at least one of the customers.

In some such instances, further steps can include examining a plurality of presentment records for bills of the credit card for a plurality of prior time periods to determine a maximum balance during the plurality of prior time periods; and estimating the total credit line as the maximum balance, as discussed above (e.g., with database system 1093, optionally using analytics module 1091 to determine the maximum).

In some cases, the at least one presentment record for the at least one of the customers includes a first presentment record for a bill of a first credit card and a second presentment record for a bill of a second credit card. The first credit card was issued to the at least one of the customers by a first one of the payment card issuers, and the second credit card was issued to the at least one of the customers by a second one of the payment card issuers. The extracting includes obtaining, from the first presentment record for the bill of the first credit card, a first credit card current balance; and obtaining, from the second presentment record for the bill of the second credit card, a second credit card current balance (e.g., with database system 1093). Also included are summing the first credit card current balance and the second credit card current balance to obtain a total current balance; and dividing the total current balance by a total credit line sum to obtain a fraction of the total credit line sum used up (e.g., with analytics module 1091). Optionally, multiply by one hundred with analytics module 1091 to obtain percent. The fraction (or percent) is indicative of the credit worthiness of the at least one of the customers.

In some such cases, further steps can include examining a plurality of presentment records for bills of the first credit card for a plurality of prior time periods to determine a first credit card maximum balance during the plurality of prior time periods (e.g., with database system 1093, optionally using analytics module 1091 to determine the maximum); examining a plurality of presentment records for bills of the second credit card for the plurality of prior time periods to determine a second credit card maximum balance during the plurality of prior time periods (e.g., with database system 1093, optionally using analytics module 1091 to determine the maximum); and estimating the total credit line sum as a sum of the first credit card maximum balance and the second credit card maximum balance (e.g., with analytics module 1091).

In some embodiments, it is helpful to know the percentage of the total amount due the person typically pays each month. Thus, in some cases, the electronic bill presentment system includes an electronic bill presentment and payment system 1006, and further steps include obtaining access to a database of bill payment data (e.g., customer database 1095, using database system 1093) in the electronic bill presentment and payment system; extracting from the database of bill presentment data a plurality of additional presentment records for at least one of the customers (e.g., using database system 1093); and, for the at least one presentment record and each of the plurality of additional presentment records, carrying out the following three steps. The three steps include determining a corresponding current balance (e.g., using database system 1093); extracting from the database of bill payment data (e.g., 1095) a corresponding payment (e.g., using database system 1093); and dividing the corresponding payment by the corresponding current balance to obtain a fractional amount paid (e.g., with analytics module 1091). Optionally, multiply by one hundred with analytics module 1091 to obtain percent.

Referring to bar graph 604, in some instances, the electronic bill presentment system includes an electronic bill presentment and payment system 1006, and a further step includes obtaining access to a database of bill payment data (e.g., customer database 1095 using database system 1093) in the electronic bill presentment and payment system. The bill payment data includes at least one payment record for a payment associated with the at least one presentment record for the at least one of the customers. The at least one payment record includes a payment date. The at least one presentment record for at least one of the customers includes a presentment record for a bill having a due date. the extracting includes determining at least one of: a time differential between the due date and the payment date; and a time differential between the payment date and a date of the bill. Appropriate fractions or percentages can then be calculated, as discussed above with regard to bar graph 604. These actions can be carried out, for example, by querying with database system 1093 to obtain the dates and using analytics module 1091 to determine the differentials and do any other needed calculations.

Referring to bar graphs 606, 608, and 610, in some instances, the electronic bill presentment system includes an electronic bill presentment and payment system 1006. The at least one presentment record for the at least one of the customers includes first through N^{th} presentment records for N bills of interest in a given time period. N is at least two. A further step includes obtaining access to a database of bill payment data (e.g., customer database 1095, using database system 1093) in the electronic bill presentment and payment system. The bill payment data includes time-stamped first through N^{th} payment records for N payments associated with the N bills of interest. A further step includes, for at least one of the bills of interest, determining a fractional payment priority rank as N minus the order in which the at least one of the bills of interest was paid divided by N minus one (e.g., with analytics module 1091). See above formula for Fractional Rank. The N bills of interest could include a number of different categories of bills, as when calculating overall payment priority as explained with respect to bar graph 606. As described with respect to bar graph 608, the N bills of interest could be limited to bills for payment cards of at least two types (e.g., store and bank). As described with respect to bar graph 610, the N bills of interest could be limited to bills for payment cards of a single type (e.g., store or bank).

In some instances, the above-discussed obtaining, extracting, and determining steps are carried out by the operator of the electronic bill presentment and payment system 1006, which entity also operates a payment card processing network (e.g., 2008) for at least one of the plurality of brands of payment card products.

In some instances, at least one entity (e.g., a landlord) decides to avail itself of a line of credit based, at least in part, on the credit worthiness and/or payment history of one or more of the customers indicating that the entity is likely to be paid late (or such decision is facilitated, e.g., by providing the entity with the appropriate data).

In some instances, at least one entity decides to make a credit extension and/or lease renewal decision based, at least in part, on the credit worthiness and/or payment history of one or more of the customers (or such decision is facilitated, e.g., by providing the entity with the appropriate data).

### System and Article of Manufacture Details

Embodiments of the invention can employ hardware and/or hardware and software aspects. Software includes but is not limited to firmware, resident software, microcode, etc. Software might be employed, for example, in connection with one or more of queries to databases 2021, 1099 (including databases 1094, 1095, 1097) by database system 1093; analytics module 1091; user interface module 1089; a terminal 122, 124, 125, 126; a reader 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader 132.

FIG. 5 is a block diagram of a system 500 that can implement part or all of one or more aspects or processes of the invention. As shown in FIG. 5, memory 530 configures the processor 520 (which could correspond, e.g., to processor portions 106, 116, 130; a processor of a terminal or a reader 132; processors of remote hosts in centers 140, 142, 144; processors of hosts and/or servers implementing various functionality such as that for querying databases 2021, 1099 (including databases 1094, 1095, 1097) by database system 1093; analytics module 1091; and/or user interface module 1089; to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010, 1006; on a computer implementing functionality such as that for querying databases 2021, 1099 (including databases 1094, 1095, 1097) by database system 1093; analytics module 1091; user interface module 1089; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 122, 124, 125, 126, 140, 142, 144, 2004, 2006, 2008, 2010, 1006; a computer implementing functionality such as that for querying databases 2021, 1099 (including databases 1094, 1095, 1097) by database system 1093; analytics module 1091; user interface module 1089; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components. A “host” includes a physical data processing system (for example, system 500 as shown in FIG. 5) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. Referring to FIG. 3, in one or more embodiments, the modules include a database module 1093, an analytics module 1091, and a user interface module 1089. As discussed above, the database module 1093 can include, for example, a graph database or a relational database management system (RDBMS) which provides access to databases 1099, 2021 via queries and the like. The analytics module can include, for example, a spreadsheet that interfaces with the database(s); custom-written code (e.g., high level) that takes the results of the database queries as an input; an analytical package such as SAS Visual Analytics software available from SAS Institute, Inc., Cary, N.C., US; that takes the results of the database queries as an input; or an in-database analytics package such as the DB Lytix package available from Fuzzy Logix, LLC Charlotte, N.C., USA. The user interface module can include, in some cases, an API 1087 when one or more techniques disclosed herein are offered as a service to a third party who accesses the API. In another aspect, the module can include a graphical user interface (GUI) 1085, such as that formed by a server serving out hypertext markup language (HTML) code to a browser of a user. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers or personal computers, located at one or more of the entities in the figures, as well as within the payment network 2008 and/or BPPS 1006. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as Neo4j, an open-source graph database or similar graph database, relational database applications (e.g., IBM DB2® software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), and the like. The computers can be programmed to implement the logic and/or data flow depicted in the figures. In some instances, messaging and the like may be in accordance with the International Organization for Standardization (ISO) Specification 8583 Financial transaction card originated messages-Interchange message specifications and/or the ISO 20022 or UNIFI Standard for Financial Services Messaging, also incorporated herein by reference in its entirety for all purposes. In some instances, some messages may be in accordance with NACHA Automated Clearing House (ACH) rules and regulations.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining access to a database of bill presentment data in an electronic bill presentment system connecting a plurality of customers with a plurality of billers, at least some of said billers comprising payment card issuers;
extracting from said database of bill presentment data at least one presentment record for at least one of said customers; and
determining, based on said at least one presentment record for said at least one of said customers, at least one of credit worthiness of said at least one of said customers and payment history of said at least one of said customers.

2. The method of claim 1, wherein said obtaining, extracting, and determining steps are carried out by an operator of said electronic bill presentment system.

3. The method of claim 2, further comprising making said at least one of credit worthiness of said at least one of said customers and payment history of said at least one of said customers available to at least one of said payment card issuers.

4. The method of claim 1, wherein said at least one of credit worthiness of said at least one of said customers and payment history of said at least one of said customers comprises at least an indication that said at least one of said customers is not prioritizing payments to at least one of said billers, further comprising said at least one of said billers offering said at least one of said customers an incentive for early payment.

5. The method of claim 1, wherein:
said at least one presentment record for said at least one of said customers comprises a presentment record for a bill of a credit card, said credit card having been issued to said at least one of said customers by one of said payment card issuers;
said extracting comprises:
obtaining from said presentment record for said bill of said credit card a current balance; and
dividing said current balance by a total credit line to obtain a fraction of said total credit line used up; and
said fraction is indicative of said credit worthiness of said at least one of said customers.

6. The method of claim 5, further comprising:
examining a plurality of presentment records for bills of said credit card for a plurality of prior time periods to determine a maximum balance during said plurality of prior time periods; and
estimating said total credit line as said maximum balance.

7. The method of claim 1, wherein:
said at least one presentment record for said at least one of said customers comprises:
a first presentment record for a bill of a first credit card, said first credit card having been issued to said at least one of said customers by a first one of said payment card issuers; and
a second presentment record for a bill of a second credit card, said second credit card having been issued to said at least one of said customers by a second one of said payment card issuers;
said extracting comprises:
obtaining from said first presentment record for said bill of said first credit card a first credit card current balance;
obtaining from said second presentment record for said bill of said second credit card a second credit card current balance;
summing said first credit card current balance and said second credit card current balance to obtain a total current balance; and
dividing said total current balance by a total credit line sum to obtain a fraction of said total credit line sum used up; and
said fraction is indicative of said credit worthiness of said at least one of said customers.

8. The method of claim 7, further comprising:
examining a plurality of presentment records for bills of said first credit card for a plurality of prior time periods to determine a first credit card maximum balance during said plurality of prior time periods;
examining a plurality of presentment records for bills of said second credit card for said plurality of prior time periods to determine a second credit card maximum balance during said plurality of prior time periods;
estimating said total credit line sum as a sum of said first credit card maximum balance and said second credit card maximum balance.

9. The method of claim 1, wherein said electronic bill presentment system comprises an electronic bill presentment and payment system, further comprising:
obtaining access to a database of bill payment data in said electronic bill presentment and payment system;
extracting from said database of bill presentment data a plurality of additional presentment record for at least one of said customers;
for said at least one presentment record and each of said plurality of additional presentment records:
determining a corresponding current balance;
extracting from said database of bill payment data a corresponding payment; and
dividing said corresponding payment by said corresponding current balance to obtain a fractional amount paid.

10. The method of claim 1, wherein said electronic bill presentment system comprises an electronic bill presentment and payment system, further comprising:
obtaining access to a database of bill payment data in said electronic bill presentment and payment system, said bill payment data including at least one payment record for a payment associated with said at least one presentment record for said at least one of said customers, said at least one payment record including a payment date;
wherein said at least one presentment record for at least one of said customers comprises a presentment record for a bill having a due date, and wherein said extracting comprises determining at least one of:
a time differential between said due date and said payment date; and
a time differential between said payment date and a date of said bill.

11. The method of claim 1, wherein:
said electronic bill presentment system comprises an electronic bill presentment and payment system;
said at least one presentment record for said at least one of said customers comprises first through N^{th} presentment records for N bills of interest in a given time period, N being at least two;
further comprising:
obtaining access to a database of bill payment data in said electronic bill presentment and payment system, said bill payment data including time-stamped first through N^{th} payment records for N payments associated with said N bills of interest; and
for at least one of said bills of interest, determining a fractional payment priority rank as N minus an order in which said at least one of said bills of interest was paid divided by N minus one.

12. The method of claim 11, wherein said N bills of interest comprise bills for payment cards of at least two types.

13. The method of claim 11, wherein said N bills of interest comprise bills for payment cards of a single type.

14. The method of claim 1, wherein said obtaining, extracting, and determining steps are carried out by an operator of said electronic bill presentment system which also operates a payment card processing network for at least one of said plurality of brands of payment card products.

15. The method of claim 1, further comprising facilitating at least one entity deciding to avail itself of a line of credit based, at least in part, on said at least one of credit worthiness of said at least one of said customers and payment history of said at least one of said customers indicating that said at least one entity is likely to be paid late.

16. The method of claim 1, further comprising facilitating at least one entity making at least one of a credit extension decision and a lease renewal decision based, at least in part. on said at least one of credit worthiness of said at least one of said customers and payment history of said at least one of said customers.

17. The method of claim 1, further comprising providing a system, wherein the system comprises distinct software modules, each of the distinct software modules being embodied on a non-transitory computer-readable storage medium, and wherein the distinct software modules comprise a database module and an analytics module;
wherein:
said obtaining of said access to said database and said extracting of said bill presentment data are carried out by said database module executing on at least one hardware processor; and
said determining of said at least one of credit worthiness of said at least one of said customers and payment history of said at least one of said customers is carried out by said analytics module executing on said at least one hardware processor.

18. An apparatus comprising:
a memory;
at least one processor operatively coupled to said memory; and
a persistent storage device operatively coupled to said memory and storing in a non-transitory manner instructions which when loaded into said memory cause said at least one processor to be operative to:
obtain access to a database of bill presentment data in an electronic bill presentment system connecting a plurality of customers with a plurality of billers, at least some of said billers comprising payment card issuers;
extract from said database of bill presentment data at least one presentment record for at least one of said customers; and
determine, based on said at least one presentment record for said at least one of said customers, at least one of credit worthiness of said at least one of said customers and payment history of said at least one of said customers.

19. The system of claim 18, wherein said instructions on said persistent storage device comprise distinct software modules, and wherein said distinct software modules comprise a database module and an analytics module;
wherein:
said database module comprises said instructions which cause said at least one processor to obtain said access to said database and to extract said at least one presentment record; and
said analytics module comprises said instructions which cause said at least one processor to determine said at least one of credit worthiness of said at least one of said customers and payment history of said at least one of said customers.

20. An apparatus comprising:
means for obtaining access to a database of bill presentment data in an electronic bill presentment system connecting a plurality of customers with a plurality of billers, at least some of said billers comprising payment card issuers;
means for extracting from said database of bill presentment data at least one presentment record for at least one of said customers; and
means for determining, based on said at least one presentment record for said at least one of said customers, at least one of credit worthiness of said at least one of said customers and payment history of said at least one of said customers.

21. An article of manufacture comprising a computer program product, said computer program product comprising:
a tangible computer-readable recordable storage medium, storing in a non-transitory manner computer readable program code, the computer readable program code comprising:
computer readable program code configured to obtain access to a database of bill presentment data in an electronic bill presentment system connecting a plurality of customers with a plurality of billers, at least some of said billers comprising payment card issuers;
computer readable program code configured to extract from said database of bill presentment data at least one presentment record for at least one of said customers; and
computer readable program code configured to determine, based on said at least one presentment record for said at least one of said customers, at least one of credit worthiness of said at least one of said customers and payment history of said at least one of said customers

22. The article of manufacture of claim 21, wherein:
said at least one presentment record for said at least one of said customers comprises a presentment record for a bill of a credit card, said credit card having been issued to said at least one of said customers by one of said payment card issuers;
said computer readable program code configured to extract said at least one presentment record comprises:
computer readable program code configured to obtain from said presentment record for said bill of said credit card a current balance; and
computer readable program code configured to divide said current balance by a total credit line to obtain a fraction of said total credit line used up; and
said fraction is indicative of said credit worthiness of said at least one of said customers.
